(19) United States
(12) Patent Application Publication
(10) Pub. No.: US 2004/0109108 A1
(43) Pub. Date: Jun. 10, 2004

(54) Liquid crystal display with ink jet color filters and manufacture method thereof

(76) Inventors: Yu-Chi Lee, Taipei (TW); Po-Hsiu Shih, Chung Ho City (TW)

Correspondence Address: THOMAS T. MOGA, ESQ., DICKINSON WRIGHT, PLLC, 1901 L. STREET, NW, SUITE 800, WASHINGTON, DC, 20036, US

(21) Appl. No.: 10/389,992

(22) Filed: Mar. 18, 2003

(30) Foreign Application Priority Data
Dec. 5, 2002 (TW) 91135329

(51) Int. Cl. G02F 1/1335

(52) U.S. Cl. 349/106

(57) ABSTRACT

A liquid crystal display with ink jet color filters and manufacture method thereof are described. The display comprises a thin film transistor array, an ink isolating wall, color filters, and a pixel electrode layer. The ink isolating layer is formed on the thin film transistor array and constructs transparent areas and non-transparent areas, black matrix, on electric control circuits. Each of the transparent areas is surrounded by an enclosing space formed by the ink isolating wall. The color filter is injected inside the enclosing space by an ink jet technology. The color filter is produced on the thin film transistor array directly, and therefore the display assembly tends to align easily, the aperture ratio is increased and the image quality of the displayer is improved.

### FIELD OF THE INVENTION

The present invention relates to a liquid crystal display and especially to a liquid crystal display with ink jet color filters.

### BACKGROUND OF THE INVENTION

Recently, liquid crystal displays (LCD) have been widely applied in electrical products, due to the rapid progress of optical technology and semiconductor technology. Moreover, with the advantages of high image quality, compact size, light weight, low driving voltage, and low power consumption, LCDs have been introduced into portable computers, personal digital assistants, color televisions, and have gradually replaced the cathode ray tubes (CRT) used for conventional displays. LCDs are becoming the mainstream display apparatus.

The main part of an LCD is a liquid crystal (LC) unit comprising two parallel transparent substrates with LC sealed therein. The main trend for LCDs is the thin film transistor (TFT) LCD. The fabrication processes of a TFT-LCD can be divided into four parts: TFT array process, color filter (CF) process, LC cell assembly process, liquid crystal module (LCM) process.

The TFT array process is used to fabricate a TFT substrate. Each TFT respectively aligns with one pixel electrode. The CF process is used to fabricate a color filter substrate. A color filter layer composed of different color filter sheets is located on the color filter substrate, and a black matrix layer surrounds each color filter sheet.

The LC cell assembly process is used to parallel assembles TFT substrate and CF substrate, and bead spacers spread between them to maintain a fixed distance, i.e. cell gap, between TFT substrate and CF substrate. LC is injected into the cell gap and then the injection opening is sealed. Basically, each pixel electrode respectively corresponds to one color filter sheet, and the black matrix layer covers TFTs and metal lines that connect different TFTs.

The LCM process is used to attach a polarizer to a panel, and electrically connect driver IC and panel circuit. Then a reflector and a back-light are assembled on the panel. After a burn-in step, the LCM process is finished.

Generally, the direction of liquid crystal molecule axes, which are controlled by TFT, determines whether each pixel is pervious to light or not. The color of each pixel is determined by the color of color filter sheet. For example, when light passes through a red color filter sheet, a red spot is shown on the panel. Mixing red, green and blue colors can show full-color images.

Since the molecular axes of liquid crystal molecules, which are between pixel electrodes and color filter sheets, have to be controlled precisely, the color filter and the TFT substrate must be aligned precisely. The tolerable error of alignment is only within several micrometers.

The thermal expansion coefficients of color filter substrates and TFT substrates are different, hence the precise alignment of pixel electrodes and color filter sheets is hard to achieve. A decreased product yield and increased production cost are caused by this problem. The problem is exacerbated by the growing size of substrates. Therefore, light leakage and coin mura effect on panel are produced.

Increasing the size of black matrix increases the alignment precision, but decreases the color contrast and brightness of the LCD. That is to say, the aperture ratio decreases and the quality of the images decrease.

### SUMMARY OF THE INVENTION

There is a need to provide an improved liquid crystal display in which the two substrates need not be aligned during the LC cell assembly process and that achieve a high aperture ratio and high-quality image. It is therefore an object of the present invention to utilize a color filter on array technology to form the color filter directly on the thin film transistor array and exactly align the color filters with the pixel electrodes.

It is another object of the present invention is to provide an ink inject technology with color resin to produce the color filter on thin film transistor array directly and reduce the manufacture cost.

To accomplish the above objectives, the present invention provides a liquid crystal display with ink jet color filters. The liquid crystal display comprises a thin film transistor array, an ink isolating wall, color filters, and a pixel electrode layer. The thin film transistor array includes a substrate and control circuits. The ink isolating wall is formed on the thin film transistor array to create transparent areas and black matrix. Each transparent area is surrounded by an enclosing space formed by the ink isolating wall. The color filters are made of color inks injected into the enclosing spaces with an ink jet technology. The pixel electrode layer is formed on the ink isolating wall and the color filters to control directions of liquid crystal molecule axes of the liquid crystal display.

The substrate utilizes a transparent glass substrate and the control circuits comprise gate electrodes, source electrodes, drain electrodes, and capacitors. The ink isolating wall is made of resin material. Each transparent area is a pixel of the liquid crystal display. The black matrix is utilized to avoid light leakage. The color filters are made of color resin inks including red, blue and green. The pixel electrode is made of indium tin oxide. The ink jet technology includes a piezoelectric ink jet technology or a thermal bubble ink jet technology.

Another aspect of the present invention is to provide a method of manufacturing a liquid crystal display with ink jet color filters. The method comprises the following steps. First, a thin film transistor array including a substrate and control circuits of the liquid crystal display is provided. Then, an ink isolating wall is formed on the thin film transistor array to create transparent areas and black matrix. Each transparent area is surrounded by an enclosing space formed by the ink isolating wall. An ink jet technology is utilized to inject color inks in the enclosing spaces for forming color filters. Finally, a pixel electrode layer is deposited on the ink isolating wall and color filters to control directions of liquid crystal molecule axes of the liquid crystal display.

Hence, the liquid crystal display with ink jet color filters and manufacture method thereof according to the present invention enhances the alignment between the color filters and pixel electrodes, improves the image quality, and reduces the manufacture cost.

### BRIEF DESCRIPTION OF THE DRAWINGS

The foregoing aspects and many of the attendant advantages of this invention are more readily appreciated as the same becomes better understood by reference to the following detailed description, when taken in conjunction with the accompanying drawings, wherein:

FIGS. 1A, 2A, 3A and 4A are top views of one embodiment according to the present invention to show sequential processes for forming the color filter on the thin film transistors array; and

FIGS. 1B, 2B, 3B and 4B are cross-sectional views of FIG. 1A, 2A, 3A and 4A respectively.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

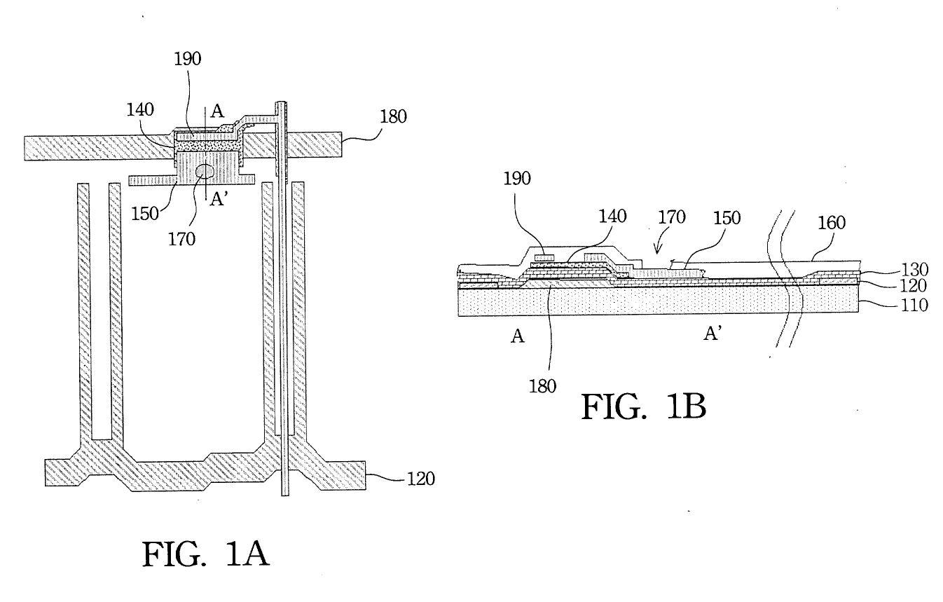

FIGS. 1A and 1B are a typical amorphous silicon thin film transistor array structure. A gate electrode 180, a capacitor 120, a first insulating layer 130, a second insulating layer 160, a source electrode 150, a drain electrode 190 and a channel electrode 140 are formed on the transparent glass substrate 110. A contact hole 170 is formed in the second insulating layer 160 to expose the source electrode 150.

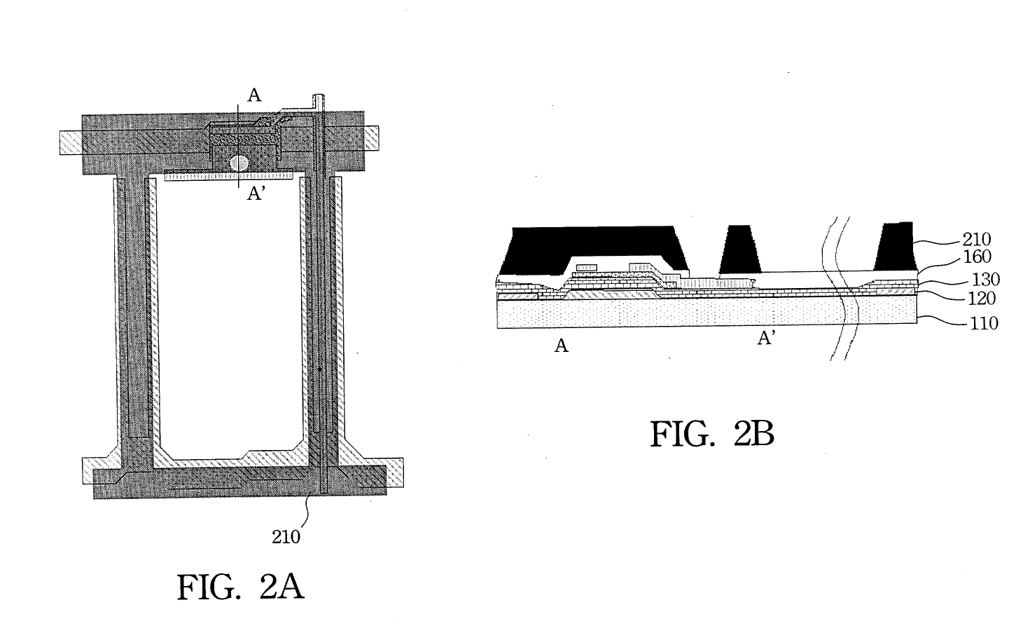

Referring to FIGS. 2A and 2B, the TFT array according to the invention further forms an ink isolating wall 210 thereon. The ink isolating wall 210 is made of an opaque material, and therefore the TFT array becomes transparent areas and non-transparent areas, that is, black matrix. Hence, the ink isolating wall 210 combines the functions of ink isolation and black matrix. The function of ink isolation means that the ink isolating wall 210 blocks ink therein to form a color filter of a pixel. The function of the black matrix is to avoid light leakage. The isolating wall 210 comprises any kind of opaque materials including resin. The present invention does not limit the material of the ink insolating wall, so long as the material is opaque and is capable of blocking ink therein.

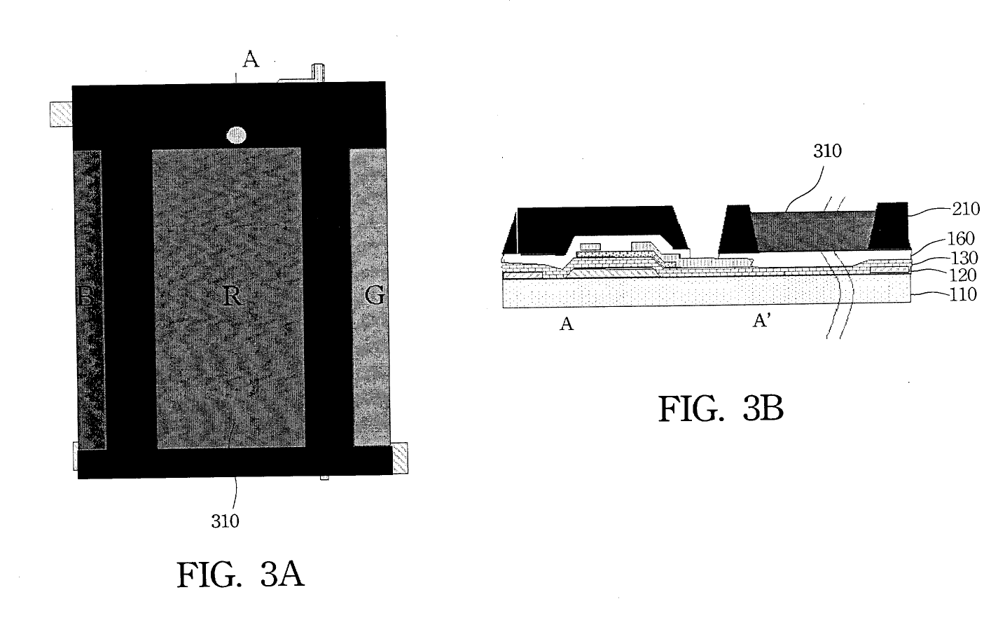

Referring to FIGS. 3A and 3B, the inks are injected in the isolating wall 210 in every pixel with respective colors of red, blue and green. The present invention utilizes the ink jet technology to inject inks into the isolating wall directly on the TFT array; therefore there is no alignment problem between pixel electrodes and color filter sheets. Because the color filters fully aim at the TFT array, the image quality is improved. Even if the size of the TFT-LCD increases, there is no alignment problem between the two glass substrates. The present invention may utilize a color resin as the color ink injected in the isolating wall for the color filter.

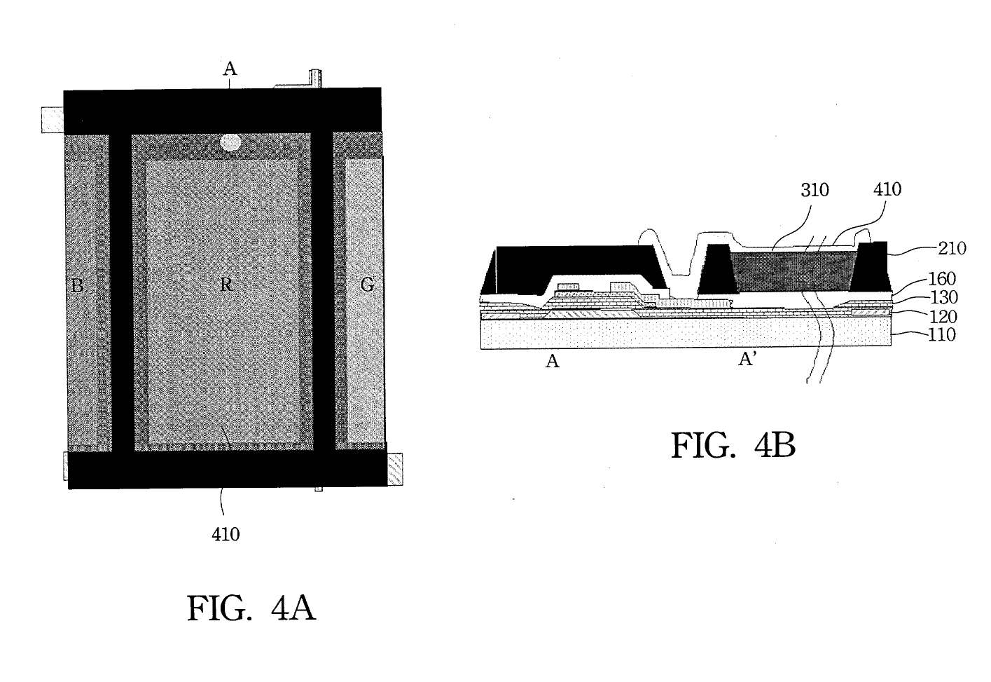

Referring to FIGS. 4A and 4B, after the ink 310 is injected in the ink isolating wall 210, a pixel electrode 410 is formed on the substrate 110 directly above the ink 310. The pixel electrode 410 is made of indium tin oxide (ITO), and therefore the pixel electrode 410 is a transparent electrode. The pixel electrode 410 controls the direction of liquid crystal molecule axes, and determines whether the pixel is pervious to light or not.

The TFT-LCD according to the present invention directly injects the ink into the TFT array. For the color filter on array technology, the other substrate only needs a common electrode. Therefore, during LC cell assembly process, the two substrates are easily assembled and the aperture ratio and the image quality increase. The present invention provides a good solution to solve the problem of larger size TFT-LCD manufacture. The larger size TFT-LCD such as a TFT-LCD television can be manufactured more easily and image quality can be better. The present invention utilizes the ink jet technology to inject the ink, such as the piezoelectric ink jet technology and the thermal bubble ink jet technology. The present invention further combines the drop on demand ink jet technology to reduce ink waste to as little as possible.

The present invention is not limited to the amorphous silicon thin film transistor array and the present invention can be utilized on a polysilicon thin film transistor array. The color ink jet technology can be also used for the polymer light-emitting diode manufacture to reduce the manufacture cost. The present invention provides a great contribution to TFT-LCD manufacture. As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A liquid crystal display with ink jet color filters, the liquid crystal display comprising:
a thin film transistor array including a substrate and control circuits of the liquid crystal display;
an ink isolating wall formed on the thin film transistor array to create transparent areas and black matrix, wherein each transparent area is surrounded by an enclosing space formed by the ink isolating wall;
color filters made of color inks injected in the enclosing spaces by an ink jet technology; and
a pixel electrode layer forming above the ink isolating wall and the color filters to control directions of liquid crystal molecule axes of the liquid crystal display.

2. The liquid crystal display of claim 1 wherein the substrate comprises a transparent glass substrate.

3. The liquid crystal display of claim 1 wherein the control circuits comprise gate electrodes, source electrodes, drain electrodes, and capacitors.

4. The liquid crystal display of claim 1 wherein the ink isolating wall is made of resin material.

5. The liquid crystal display of claim 1 wherein each of the transparent area is a pixel of the liquid crystal display.

6. The liquid crystal display of claim 1 wherein the black matrix is utilized to avoid light leakage.

7. The liquid crystal display of claim 1 wherein the color filters comprise red, green and blue color filters.

8. The liquid crystal display of claim 1 wherein the color filters are made of color resin ink.

9. The liquid crystal display of claim 1 wherein the pixel electrode is made of indium tin oxide.

10. The liquid crystal display of claim 1 wherein the ink jet technology includes a piezoelectric ink jet technology.

11. The liquid crystal display of claim 1 wherein the ink jet technology includes a thermal bubble ink jet technology.

12. A method of manufacturing liquid crystal display with ink jet color filters, the method comprising:
providing a thin film transistor array including a substrate and control circuits of the liquid crystal display;
forming an ink isolating wall on the thin film transistor array to create transparent areas and black matrix, wherein each transparent area is surrounded by an enclosing space formed by the ink isolating wall;
utilizing an ink jet technology to inject color inks in the enclosing spaces for forming color filters; and
depositing a pixel electrode layer on the ink isolating wall and the color filters to control directions of liquid crystal molecule axes of the liquid crystal display.

13. The method of claim 12 wherein the substrate comprises a transparent glass substrate.

14. The method of claim 12 wherein the control circuits comprise gate electrodes, source electrodes, drain electrodes, and capacitors.

15. The method of claim 12 wherein the ink isolating wall is made of resin material.

16. The method of claim 12 wherein each of the transparent areas is a pixel of the liquid crystal display.

17. The method of claim 12 wherein the black matrix is utilized to avoid light leakage.

18. The method of claim 12 wherein the color filters comprise red, green and blue color filters.

19. The method of claim 12 wherein the color filters are made of color resin ink.

20. The method of claim 12 wherein the pixel electrode is made of indium tin oxide.

21. The method of claim 12 wherein the ink jet technology includes a piezoelectric ink jet technology.

22. The method of claim 12 wherein the ink jet technology includes a thermal bubble ink jet technology.
